(19) United States
(12) Patent Application Publication
(10) Pub. No.: US 2017/0104590 A1
(43) Pub. Date: Apr. 13, 2017

(54) Method and Apparatus for Error Correcting Code Based Public Key Encryption Schemes

(71) Applicant: Yongge Wang, Matthews, NC (US)

(72) Inventor: Yongge Wang, Matthews, NC (US)

(21) Appl. No.: 15/270,824

(22) Filed: Sep. 20, 2016

Related U.S. Application Data
(60) Provisional application No. 62/240,182, filed on Oct. 12, 2015.

(51) Int. Cl. H04L 9/08; H03M 13/05; H04L 9/14

(52) U.S. Cl. CPC H04L 9/0816; H04L 9/14; H03M 13/05; H04L 2209/24

(57) ABSTRACT

This invention discloses a method and system for generating a private key and a corresponding public key. These keys can be used for encrypting a message into a ciphertext for transmission through an insecure communication channel, and for decrypting said ciphertext into a clear plaintext. The goal of the present invention is to provide encryption and decryption methods of the McEliece type which are capable of improving the security level of a post-quantum cryptosystem. In one embodiment, this object is achieved by three methods: a method for creating a public key from a private linear code generator matrix, a method for encrypting a message into a ciphertext and a method for decrypting the ciphertext into a plaintext. The key generation and encryption methods of the present invention comprises the following steps:
selecting an [n, k] linear code generator matrix Gₛ=[g₀, . . . , gₙ] over GF(q) as the private key, where k, r, n and q are positive integers and where g₀, . . . , gₙ₋₁ are length k column vectors; selecting k×r random matrices C₀, . . . , Cₙ₋₁; selecting a k×k non-singular matrix S; selecting an n(r+1)×n(r+1) matrix A; selecting an n(r+1)×n(r+1) permutation matrix P; and setting the public key as G=S[g₀, C₀, . . . , gₙ₋₁, Cₙ₋₁]AP.
receiving a public key G, which is a k×n(r+1) matrix over a finite field GF(q); generating an error vector e having elements in GF(q) and having a predetermined weight t; and encrypting a message vector m to a ciphertext vector y=mG+e.
   The main difference between the proposed cryptosystem and known variants of the McEliece cryptosystem consists in the way the private generator matrix is disguised into the public one by inserting and mixing random columns within the private generator matrix.

### CROSS-REFERENCES TO RELATED APPLICATIONS

This application is entitled to the benefit of Provisional Patent Application Ser. No. 62/240,182 filed on Oct. 12, 2015.

### U.S. PATENT DOCUMENTS

Marco Baldi, Marco Bianchi, Franco Chiaraluce, Joachim Jakob Rosenthal, and Davide Mose' Schipani. Method and apparatus for public-key cryptography based on error correcting codes. U.S. Pat. No. 9,191,199 B2 (2015)
Martin Tomlinson, Cen Jung Tjhai. Public key cryptosystem based on goppa codes and puf based random generation. U.S. Pat. No. 8,958,553 B2 (2015)

### FOREIGN PATENT DOCUMENTS

Martin Tomlinson and Cen Jung Tjhai. Public key encryption using error correcting codes. WO2012066328 A1 (2012)
Eran Kanter, Ido Kanter. A secure and linear public-key cryptosystem based on parity-check error-correcting code. WO2001050675 A2 (2001).

### OTHER PUBLICATIONS

M. Baldi, M. Bodrato, and F. Chiaraluce. A new analysis of the McEliece cryptosystem based on QC-LDPC codes. In Security and Cryptography for Networks, pages 246-262. Springer, 2008.
T Berger and P Loidreau. How to mask the structure of codes for a cryptographic use. Designs, Codes and Cryptography, 35(1):63-79, 2005.
D. Bernstein, T. Lange, and C. Peters. Wild McEeliece. In Selected Areas in Cryptography, pages 143-158. Springer, 2011.
D. J. Bernstein, T. Lange, and C. Peters. Attacking and defending the McEliece cryptosystem. In Post-Quantum Cryptography, pages 31-46. Springer, 2008.
A. Couvreur, P. Gaborit, V. Gauthier-Umaña, A. Otmani, and J.-P. Tillich. Distinguisher-based attacks on public-key cryptosystems using ReedSolomon codes. Designs, Codes and Cryptography, pages 1-26, 2013.
A. Couvreur, I. Márquez-Corbella, and R. Pellikaan A polynomial time attack against algebraic geometry code based public key cryptosystems. In Proc. ISIT, pages 1446-1450. IEEE, 2014.
A. Couvreur, A. Otmani, and J.-P. Tillich. Polynomial time attack on wild McEliece over quadratic extensions. In EUROCRYPT 2014, pages 17-39. Springer, 2014.
J.-C. Faugere, V. Gauthier-Umana, A. Otmani, L. Perret, and J.-P. Tillich. A distinguisher for high-rate McEliece cryptosystems. IEEE Trans. Information Theory, 59(10):6830-6844, 2013.
J.-C. Faugere, A. Otmani, L. Perret, and J.-P. Tillich. Algebraic cryptanalysis of McEliece variants with compact keys. In Eurocrypt 2010, pages 279-298. Springer, 2010.
H. Janwa and O. Moreno. McEliece public key cryptosystems using algebraic-geometric codes. Designs, Codes and Cryptography, 8(3):293-307, 1996.
P. J. Lee and E. F. Brickell. An observation on the security of McEliece's public-key cryptosystem. In EUROCRYPT'88, pages 275-280. Springer, 1988.
C. Löndahl and T. Johansson. A new version of McEliece PKC based on convolutional codes. In Information and Communications Security, pages 461-470. Springer, 2012.
I. Márquez-Corbella and R. Pellikaan Error-correcting pairs for a public-key cryptosystem. arXiv preprint arXiv:1205.3647, 2012.
R. J. McEliece. A public-key cryptosystem based on algebraic coding theory. DSN progress report, 42(44):114-116, 1978.
R. Misoczki, J.-P. Tillich, N. Sendrier, and P. Barreto. MDPC-McEliece: New McEliece variants from moderate density parity-check codes. In Proc. ISIT, pages 2069-2073. IEEE, 2013.
H. Niederreiter. Knapsack-type cryptosystems and algebraic coding theory. Problems of Control and Information Theory, 15(2):159-166, 1986.
C. Peters. Information-set decoding for linear codes over F_{q}. In Post-Quantum Cryptography, pages 81-94. Springer, 2010.
Eugene Prange. The use of information sets in decoding cyclic codes. IRE Trans. Information Theory, 8(5):5-9, 1962.
V Sidelnikov. A public-key cryptosystem based on binary Reed-Muller codes. Discrete Mathematics and Applications, 4(3):191-208, 1994.
V. M Sidelnikov and S. Shestakov. On insecurity of cryptosystems based on generalized Reed-Solomon codes. Discrete Mathematics and Applications, 2(4):439-444, 1992.
Yongge Wang. Quantum Resistant Random Linear Code Based Public Key Encryption Scheme RLCE. Proc. ISIT 2016. IEEE Press, 2016.
C. Wieschebrink. Two NP-complete problems in coding theory with an application in code based cryptography. In Proc. IEEE ISIT, pages 1733-1737. IEEE Press, 2006.
C. Wieschebrink. Cryptanalysis of the Niederreiter public key scheme based on GRS subcodes. In Post-Quantum Cryptography, pages 61-72. Springer, 2010.

### BACKGROUND

Field of the Invention

The present invention relates to methods for public-key cryptography encryption schemes based on linear error correcting codes, and to corresponding encryption and decryption apparatus.

The present invention further relates to computerised methods and systems for encrypting and decrypting data using public key encryption techniques, and to computerised methods and systems for communications using such techniques, as well as other applications thereof. The basic types of things that the invention improves include two kinds of techniques. The first technique is a method and system to integrate randomness within linear error-correcting codes' generator matrices. The second technique is a method and system to use randomized generator matrices as public-keys for encryption schemes for secure communications.

Discussion of Prior Art

With rapid development for quantum computing techniques, our society is concerned with the security of current Public Key Infrastructures (PKI) which are fundamental for Internet services. The core components for current PKI infrastructures are based on public cryptographic techniques such as RSA and DSA. However, it has been shown that these public key cryptographic techniques could be broken by quantum computers. Thus it is urgent to develop public key cryptographic systems that are secure against quantum computing.

Since McEliece encryption scheme (1978) was introduced more than thirty years ago, it has withstood many attacks and still remains unbroken for general cases. It has been considered as one of the candidates for post-quantum cryptography since it is immune to existing quantum computer algorithm attacks. The original McEliece cryptographic system is based on binary Goppa codes. Several variants have been introduced to replace Goppa codes in the McEliece encryption scheme. For instance, Niederreiter (1986) proposed the use of generalized Reed-Solomon codes and later, Berger and Loidreau (2005) proposed the use of sub-codes of generalized Reed-Solomon codes, Sidelnikov (1994) proposed the use of Reed-Muller codes, Janwa and Moreno (1996) proposed the use of algebraic geometry codes, Baldi et al (2008) proposed the use of LDPC codes, Misoczki et al (2013) proposed the use of MDPC codes, and Löndahl and Johansson (2012) proposed the use of convolutional codes. Most of them have been broken though MDPC/LDPC code based McEliece encryption schemes and the original binary Goppa code based McEliece encryption scheme are still considered secure.

Goppa code based McEliece encryption scheme is hard to attack since Goppa codes share many characteristics with random codes. Motivated by Faugere et al's (2010) algebraic attacks against quasi-cyclic and dyadic structure based compact variants of McEliece encryption scheme, Faugere et al (2011) designed an efficient algorithm to distinguish a random code from a high rate Goppa code. Márquez-Corbella and Pellikaan (2012) simplified the distinguisher using Schur component-wise product of codes. The Schur product codes are used to define the square of a code which can be used to distinguish a high rate Goppa code from a random code.

We first briefly review Goppa codes and McEliece scheme. For given parameters q, n≦q, and t, let g(χ) be a polynomial of degree t over GF(q). Assume that g(χ) has no multiple zero roots and α₀, . . . , αₙ₋₁εGF(q) be different non root elements for g(χ). The following subspace C_{Goppa}(g) defines the code words of an [n, k, d] binary Goppa code where d≧2t+1. This binary Goppa code C_{Goppa}(g) has dimension k≧n−tm and corrects t errors.

$${C}_{Goppa} ( g ) = \{ c ∈ {\{ 0 , 1 \}}^{n} \text{:} {\sum }_{i = 0}^{n - 1} \frac{{c}_{i}}{x - {α}_{i}} ≡ 0 mod g ( x ) \} .$$

Furthermore, if g(χ) is irreducible, then C_{Goppa}(g) is called an irreducible Goppa code. The parity check matrix H for the Goppa codes looks as follows:

$$\begin{matrix}{V}_{t} ( x , y ) = ( \begin{matrix}1 & 1 & … & 1 \\ {α}_{0}^{1} & {α}_{1}^{1} & … & {α}_{n - 1}^{1} \\ … & … & ⋱ & … \\ {α}_{0}^{t} & {α}_{1}^{t} & … & {α}_{n - 1}^{t}\end{matrix} ) ( \begin{matrix}\frac{1}{g ( {α}_{0} )} & & \\ & ⋱ & \\ & & \frac{1}{g ( {α}_{n - 1} )}\end{matrix} ) & ( 1 ) \\ where \\ x = [ {α}_{0} , … , {α}_{n - 1} ] and y = [ \frac{1}{g ( {α}_{0} )} , … , \frac{1}{g ( {α}_{n - 1} )} ] . & \end{matrix}$$

The McEliece scheme (1978) is described as follows. For the given parameters n and t, choose a binary Goppa code based on an irreducible polynomial g(χ) of degree t. Let G be the k×n generator matrix for the Goppa code. Select a random dense k×k nonsingular matrix S and a random n×n permutation matrix P. Then the public key is G′=SGP which generates a linear code with the same rate and minimum distance as the code generated by G. The private key is G.

Encryption. For a k-bit message block m, choose a random row vector z of length n and weight t. Compute the cipher text χ=mG′+z

Decryption. For a received ciphertext χ, first compute χ′=χP⁻¹. Next use an error-correction algorithm to recover m′=mS and compute the message m as m=m′S⁻¹.

Sidelnikov and Shestakov (1992) show that for the generalized Reed-Solomon code based McEliece encryption scheme, one can efficiently recover the private parameters for the generalized Reed-Solomon code from the public key. Using component-wise product of codes and techniques, Wieschebrink (2010) shows that Berger and Loidreau's sub codes (2005) of Niederreiter's scheme could be broken efficiently also. Couvreur et al (2013) proposed a general distinguisher based filtration technique to recover keys for generalized Reed-Solomon code based McEliece scheme and Couvreur, Márquez-Corbella, and Pellikaan (2014) used filtration attacks to break Janwa and Moreno's (1996) algebraic geometry code based McEliece encryption scheme. The filtration attack was recently used by Couvreur et al (2014) to attack Bernstein et al's (2011) wild Goppa code based McEliece scheme.

General Goppa code based McEliece schemes are still immune from these attacks. However, based on the new development of cryptanalysis techniques against linear code based cryptographic systems in the recent years, it is important to systematically design random linear code based cryptographic systems defeating these attacks. Motivated by this observation, this invention presents a systematic approach of designing public key encryption schemes using any linear codes. For example, we can even use Reed-Solomon codes to design McEliece encryption scheme while it is insecure to use Reed-Solomon codes in the original McEliece scheme. Since our design of linear code based encryption scheme embeds randomness in each column of the generator matrix, it is expected that, without the corresponding private key, these codes are as hard as random linear codes for decoding.

The most powerful attacks on McEliece cryptosystem is the information-set decoding attack which was introduced by Prange (1962). In an information-set decoding approach, one finds a set of coordinates of a received ciphertext which are error-free and that the restriction of the code's generator matrix to these positions is invertible. The original message can then be computed by multiplying the ciphertext with the inverse of the sub-matrix. Improvements of the information-set decoding attack have been proposed by Lee-Brickell (1988), Leon (1988), Stern (1989), May-Meurer-Thomae (2011), Becker-Joux-May-Meurer (2012), and May-Ozerov (2015). Bernstein, Lange, and Peters (2008) presented an exact complexity analysis on information-set decoding attack against McEliece cryptosystem. These said attacks are against binary linear codes and are not applicable when the underlying field is GF(p^{m}) for a prime p. Peters (2010) presented an exact complexity analysis on information-set decoding attack against McEliece cryptosystem over GF(p^{m}). These information-set decoding techniques are used to select example parameters for this invention.

Several inventors have created several types of techniques to design McEliece type public key encryption schemes. U.S. Pat. No. 9,191,199 B2 to Baldi, Bianchi, Chiaraluce, Rosenthal, and Schipani (2015) discloses a method for designing McEliece cryptosystem based public key encryption schemes by defining n×n transformation matrices Q with form Q=R+T, where the matrix R is a rank-z matrix and the matrix T is some other matrix rendering Q non-singular. Using this family of Q matrices instead of McEliece scheme's permutation matrices, the inventors proposed a cryptosystem using Goppa codes and RS codes. The afore mentioned patent is related to constructing McEliece type encryption schemes by modifying the permutation matrix content instead of adding randomness to the generator matrices columns and is limited in adding sufficient randomness in the public keys to make the scheme secure. U.S. Pat. No. 8,958,553 B2 to Tomlinson and Tjhai (2015) discloses a method for providing additional features to the original McEliece system which enhance the bandwidth efficiency. This patent assumes the existence of a secure McEliece type encryption scheme and is limited in constructing secure McEliece type encryption schemes. This patent is also published as international patent WO2012066328 A1 (2012). The international patent WO2001050675 A2 to Kanter and Kanter (2001) discloses a method for randomly flipping some or all of the bits in a McEliece encryption public-key. This patent is limited in generating a sequence of public keys instead of one public keys. Thus it is not efficient in practice.

### SUMMARY OF THE INVENTION

The goal of the present invention is to provide encryption and decryption methods of McEliece type which are capable of improving the security level of a cryptosystem. In this invention, the term “cryptosystem” is to be understood as relating to both a method of encryption and a corresponding method of decryption.

This object is achieved by following three methods: a method for creating a public key from a private linear code generator matrix, a method for encrypting a message to a ciphertext and a method for decrypting the ciphertext. The key generation and encryption methods of the present invention comprises the following steps:
selecting an [n, k] linear code generator matrix Gₛ=[g₀, . . . , gₙ] over GF(q) as the private key, where k, r, n and q are positive integers and where g₀, . . . , gₙ₋₁ are length k column vectors; selecting k×r random matrices C₀, . . . , Cₙ₋₁; selecting a k×k non-singular matrix S; selecting an n(r+1)×n(r+1) matrix A; selecting an n(r+1)×n(r+1) permutation matrix P; and setting the public key as G=S[g₀, C₀, . . . , gₙ₋₁, Cₙ₋₁]AP.
receiving a public key G, which is a k×n(r+1) matrix over a finite field GF(q); generating an error vector e having elements in GF(q) and having a predetermined weight t; and encrypting a message vector m to a ciphertext vector y=mG+e.

The main difference between the proposed cryptosystem and known variants of the McEliece cryptosystem consists in the way the private generator matrix is disguised into the public one by inserting and mixing random columns within the private generator matrix.

### BRIEF DESCRIPTION OF THE DRAWINGS

For a more complete understanding of the invention, reference is made to the following description and accompanying drawings, in which:

FIG. 1 is a schematic diagram illustrating a process according to an embodiment of the invention, showing steps taken for generating a private key and steps taken for generating a corresponding public key for a public key encryption scheme;

FIG. 2 is a schematic diagram illustrating a process according to an embodiment of the invention, showing steps taken for encrypting a message using a public key and steps taken for decrypting a cipher text using a corresponding private key; and

FIG. 3 is a schematic diagram illustrating a process according to an embodiment of the invention, showing steps taken for including a partial message within the error vector and steps taken for including a message authentication tag within the error vector.

### DESCRIPTION OF INVENTION

In this invention, we will use q=2^{m} or q=p^{m} for a prime p and our discussion will be based on the field GF(q) through out this invention. Letters such as a, b, e, ƒ, g are used to denote row or column vectors over GF(q). It should be clear from the context whether a specific letter represents a row vector or a column vector.

The Random Linear Code based Encryption scheme RLCE of the present invention is described in the following paragraphs.

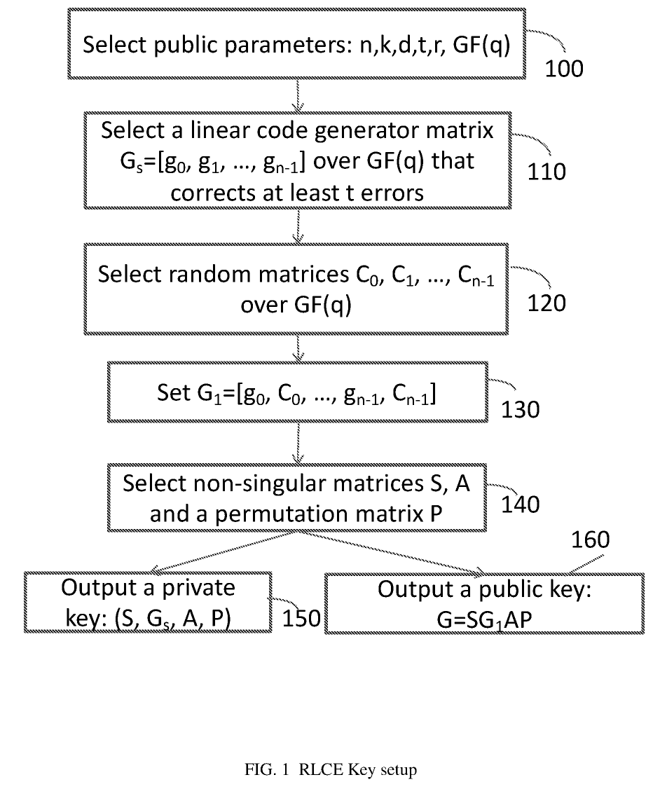

FIG. 1 describes a process for generating a private key and for generating a corresponding public key for the proposed public key encryption scheme. Referring therefore to FIG. 1, the public parameter selection engine 100 chooses n, k, d, t, r>0, and GF(q) with the property that n−k+1≧d≧2t+1. The private linear code generator matrix selection engine 110 chooses a k×n generator matrix Cₛ=[g₀, . . . , gₙ₋₁] for an [n, k, d] linear code such that there is an efficient decoding algorithm to correct at least t errors for this linear code given by Cₛ. Random matrix selection engine 120 chooses k×r matrices C₀, C₁, . . . , Cₙ₋₁εGF(q)^{k×r} uniformly at random. Matrix column mixing engine 130 defines

G₁=[g₀,C₀,g₁,C₁,gₙ₋₁,Cₙ₋₁] (2)

to be a k×n(r+1) matrix by inserting random matrices C₀, C₁, . . . , Cₙ₋₁ into Gₛ. The second random matrix selection engine 140 chooses dense nonsingular (r+1)×(r+1) matrices A₀, . . . , Aₙ₋₁εGF(q)^{(r+1)×(r+1)} uniformly at random and defines

$$A = [ \begin{matrix}{A}_{0} & & & \\ & {A}_{1} & & \\ & & ⋱ & \\ & & & {A}_{n - 1}\end{matrix} ] \qquad ( 3 )$$

to be an n(r+1)×n(r+1) nonsingular matrix. The engine 140 also chooses a random dense k×k nonsingular matrix S and chooses a random n(r+1)×n(r+1) permutation matrix P. The public key 160 is the k×n(r+1) matrix G=SG₁AP and the private key 150 is the tuple (S, Gₛ, P, A).

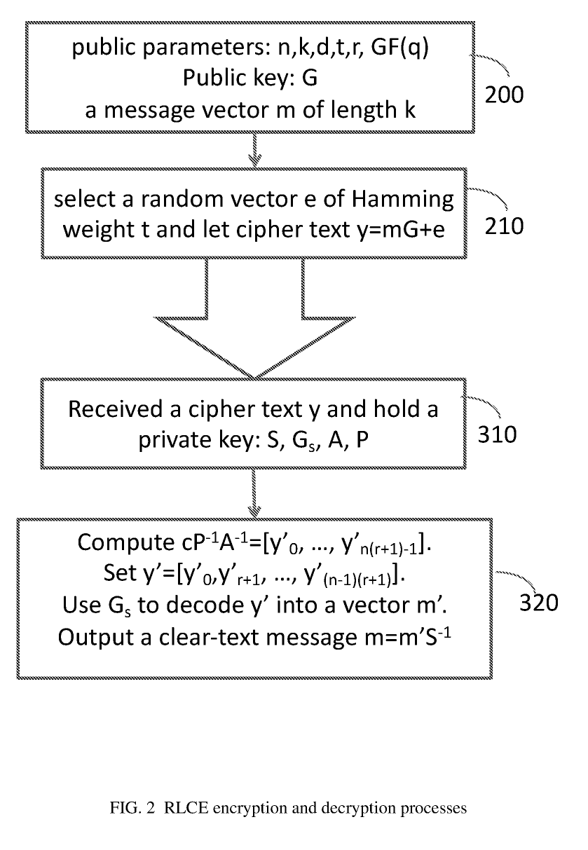

FIG. 2 describes a process for encrypting a clear text message using the public key 160 and a process for decrypting a ciphertext to a clear text message using the private key 150. Referring therefore to FIG. 2, for given public parameters n,k,d,t,r,GF(q), a public key G, and a row message vector mεGF(q)^{k} in the box 200, the encryption engine 210 chooses a random row vector e=[e₀, . . . , eₙ₍ᵣ₊₁₎₋₁]εGF(q)^{n(r+1)} whose Hamming weight is at most t and computes the cipher text as y=mG+e.

The receiver 310 holds the private key S, Gₛ, A, P and receives the ciphertext y. For the received cipher text y [y₀, . . . , yₙ₍ᵣ₊₁₎₋₁], the decryption engine 320 computes

$$\begin{matrix}{yP}^{- 1} {A}^{- 1} = [ {y}_{0}^{′} , … , {y}_{n ( r + 1 ) - 1}^{′} ] = {mSG}_{1} + {eP}^{- 1} {A}^{- 1} & ( 4 ) \\ where \\ {A}^{- 1} = [ \begin{matrix}{A}_{0}^{- 1} & & & \\ & {A}_{1}^{- 1} & & \\ & & ⋱ & \\ & & & {A}_{n - 1}^{- 1}\end{matrix} ] & \end{matrix}$$

Let y′=[y′₀, yᵣ₊₁, . . . , y′₍ₙ₋₁₎₍ᵣ₊₁₎] be a length n row vector selected from the length n(r+1) row vector yP⁻¹ A⁻¹. Then y′=mSGₛ+e′ for some error vector e′εGF(q)ⁿ. Let e″=eP⁻¹=[e″₀, . . . , e″ₙ₍ᵣ₊₁₎₋₁] and e″ᵢ=[e″ᵢ₍ᵣ₊₁₎, . . . , e″ᵢ₍ᵣ₊₁₎₊ᵣ] be a sub-vector of e″ for i≦n−1. Then e′[i] is the first element of e″ᵢAᵢ⁻¹. Thus e′ [i]≈0 only if e″ᵢ is non-zero. Since there are at most t non-zero sub-vectors e″, the Hamming weight of e′εGF(q)ⁿ is at most t. Using the efficient decoding algorithm, the receiver computes m′=mS and m=m′S⁻¹. Finally, the receiver calculates the Hamming weight w=weight(y−mG). If w≦t then the decryption engine 320 outputs m as the decrypted plaintext. Otherwise, the decryption engine 320 outputs an error.

Comment 1. In the design of RLCE scheme, the permutation matrix P has two purposes. The first purpose is to hide the supports of the underlying encoding scheme generator matrix (this is necessary if the supports of the underlying encoding scheme are unknown). The second purpose is to hide the positions and combinations of the column vectors gᵢ and Cᵢ.

Comment 2. In the RLCE decryption process, the receiver checks whether the Hamming weight w=weight(y−mG) is smaller than t. This step is used to defeat chosen ciphertext attacks (CCA). In a CCA attack, an adversary gives a random vector y=[y₀, . . . , yₙ₍ᵣ₊₁₎₋₁] (which is not a valid ciphertext) to the decryption oracle to learn a decrypted value. This decrypted value could be used to obtain certain information about the private generator matrix Gₛ. Alternatively, one may use an appropriate padding scheme to pad a message before encryption. For example, one may use the hash output (or a message authentication tag) as the error vector for the encryption process. Then it is sufficient for the decryption process to verify whether the decrypted message has the correct padding strings to defeat the CCA attacks.

We first use the following theorem to show that any single column of the underlying generator matrix G could be completely randomized in a RLCE public key G.

Theorem 0.0.1 Let Gₛ=[g₀, . . . , gₙ₋₁]εGF(q)^{k×(n-1)} be a linear code generator matrix. For any randomly chosen full rank k×(r+1) matrix R₀εGF(g)^{k×(r+1)}, there exists a k×k nonsingular matrix S, a (r+1)×(r+1) matrix A₀, and a k×r matrix C₀εGF(g)^{k×r} such that

R₀=S[g₀,C₀]A₀ (5)

Proof.

By the fundamental properties of matrix equivalence, for two m×n matrices A, B of the same rank, there exist invertible m×m matrix P and n×n invertible matrix Q such that A=PBQ. The theorem could be proved using this property and the details are omitted here.

Let R=[R₀, . . . , Rₙ₋₁]εGF(q)^{k×n(r+1)} be a fixed random linear code generator matrix. Theorem 0.0.1 shows that for any generator matrix Gₛ (e.g., a Reed-Solomon code generator matrix), we can choose matrices S and A₀ so that the first r+1 columns of the RLCE scheme public key G (constructed from Gₛ) are identical to R₀. However, we cannot use Theorem 0.0.1 to continue the process of choosing A₁, . . . , Aₙ₋₁ to obtain G=R since S is fixed after A₀ is chosen. Indeed, it is straightforward to show that one can use Theorem 0.0.1 to continue the process of choosing A₁, . . . , Aₙ₋₁ to obtain G=R if and only if there exists a k×k nonsingular matrix S such that, for each i≦n−1, the vector Sgᵢ lies in the linear space generated by the column vectors of Rᵢ. A corollary of this observation is that if Rᵢ generates the full k dimensional space, then each linear code could have any random matrix as its RLCE public key.

Theorem 0.0.2 Let R=[R₀, . . . , Rₙ₋₁]εGF(g)^{k×n (r+1)} and Gₛ=[g₀, . . . , gₙ₋₁] εGF(g)^{k×n} be two fixed MDS linear code generator matrices. If r+1≧k, then there exist A₀, . . . , Aₙ₋₁εGF(g)^{(r+1)×(r+1)} and C₀, . . . , Cₙ₋₁εGF(g)^{k×r} such that R=[g₀, C₀, . . . , gₙ₋₁, Cₙ₋₁]A where A is in the format of (3).

Proof. Without loss of generality, we may assume that r=k−1. For each 0≦i≦n−1, choose a random matrix CᵢεGF(g)^{k×r} such that Gᵢ=[gᵢ, Cᵢ] is an k×k invertible matrix.

The above Theorem 0.0.2 shows that in the RLCE scheme, we must have r<k−1. Otherwise, for a given public key GεGF(g)^{k×n(r+1)}, the adversary can choose a Reed-Solomon code generator matrix GₛεGF(g)^{k×n} and compute A₀, . . . , Aₙ₋₁εGF(q)^{r×r} and C₀, . . . , Cₙ₋₁εGF(g)^{k×r} such that G=[g₀, C₀, . . . , gₙ₋₁, Cₙ₋₁]A. In other words, the adversary can use the decryption algorithm corresponding to the generator matrix Gₛ to break the RLCE scheme.

Theorem 0.0.2 also implies an efficient decryption algorithm for random [n, k] linear codes with sufficiently small t of errors. Specifically, for an [n, k] linear code with generator matrix RεGF(g)^{k×n}, if

$$t \leq \frac{n - {k}^{2}}{2 k} ,$$

then one can divide R into m=2t+k blocks R=[R₀, . . . , Rₘ₋₁]. Theorem 0.0.2 can then be applied to construct an equivalent [m, k] Reed-Solomon code with generator matrix GₛεGF(g)^{k×m}. Thus it is sufficient to decrypt the equivalent Reed-Solomon code instead of the original random linear code. For McEliece based encryption scheme, Bernstein, Lange, and Peters (2008) recommends the use of 0.75 (=k/n) as the code rate. Thus Theorem 0.0.2 has no threat on these schemes.

For

$$t \leq \frac{n - {k}^{2}}{2 k} ,$$

the adversary is guaranteed to succeed in breaking the system. Since multiple errors might be located within the same block Rᵢ with certain probability. For a given t that is slightly larger than

$$\frac{n - {k}^{2}}{2 k} ,$$

the adversary still has a good chance to break the system using the above approach. It is recommended that t is significantly larger than

$$\frac{n - {k}^{2}}{2 k} .$$

For the RLCE scheme, this means that r should be significantly smaller than k. This is normally true since k is very larger for secure RLCE schemes.

In following paragraphs, we list heuristic and experimental evidences that the RLCE public key G shares the properties of random linear codes. We believe that the security of the RLCE scheme is equivalent to decoding a random linear code.

We first show that certain information about the private generator matrix Gₛ is leaked if the decryption process does neither include padding scheme validation nor include ciphertext correctness validation. However, it is not clear whether this kind of information leakage would help the adversary to break the RLCE encryption scheme. We illustrate this using the parameter r=1.

Assume that G₁=[g₀, r₀, g₁, r₁, . . . , gₙ₋₁, rₙ₋₁] and G=SG₁AP. The adversary chooses a random vector y=[y₀, . . . , y₂ₙ₋₁]εGF(q)²ⁿ⁻¹ and gives it to the decryption oracle which outputs a vector χεGF(q)^{k}. Let yP⁻¹ A⁻¹=[y′₀, . . . , y′₂ₙ₋₁] and

$${A}_{i} = [ \begin{matrix}{a}_{i , 00} & {a}_{i , 01} \\ {a}_{i , 10} & {a}_{i , 11}\end{matrix} ] .$$

Then we have

$$\begin{matrix}xG - y = xS [ {g}_{0} , {r}_{0} , {g}_{1} , {r}_{1} , … , {g}_{n - 1} , {r}_{n - 1} ] AP - y \\ = [ … , xS [ {g}_{i} , {r}_{i} ] {A}_{i} , … ] P - y \\ = [ … , [ {y}_{2 i}^{′} , {xSr}_{i} ] {A}_{i} , … ] P + e - y \\ = [ … , [ {y}_{2 i}^{′} , {y}_{2 i + 1}^{′} ] {A}_{i} , … ] P + \\ [ … , [ 0 , {xSr}_{i} - {y}_{2 i + 1}^{′} ] {A}_{i} , … ] P + e - y \\ = y + [ … , [ 0 , {xSr}_{i} - {y}_{2 i + 1}^{′} ] {A}_{i} , … ] P + e - y \\ = [ … , [ {xSr}_{i} - {y}_{2 i + 1}^{′} ) {a}_{i , 10} , \\ ( {xSr}_{i} - {y}_{2 i + 1}^{′} ) {a}_{i , 11} ] , … ] P + e\end{matrix} \qquad ( 6 )$$

where e is a row vector of Hamming weight at most t. From the identity (6), one can calculate a list of potential values for cᵢ=a_{i,10}/a_{i,11}. The size of this list is (²ⁿ₂). For each value in this list, one obtains the corresponding two column vectors [ƒ₀, ƒ₁]=S[gᵢ, rᵢ]Aᵢ from the public key G. Then one has

$$[ {f}_{0} , {f}_{1} ] [ \begin{matrix}1 & 0 \\ - {c}_{i} & 1\end{matrix} ] = S [ {g}_{i} , {r}_{i} ] [ \begin{matrix}{a}_{i , 00} & {a}_{i , 01} \\ {c}_{i} {a}_{i , 11} & {a}_{i , 11}\end{matrix} ] [ \begin{matrix}1 & 0 \\ - {c}_{i} & 1\end{matrix} ] = S [ {g}_{i} , {r}_{i} ] [ \begin{matrix}{a}_{i , 00} - {c}_{i} {a}_{i , 01} & {a}_{i , 01} \\ 0 & {a}_{i , 11}\end{matrix} ] \qquad ( 7 )$$

That is, ƒ₀−cᵢƒ₁=(a_{i,00}−cᵢa_{i,01})Sgᵢ. Thus, for each candidate permutation matrix P, one can calculate a matrix SGₛB where B=diag[a_{0,00}−c₀a_{0,01}, . . . , a_{n-1,00}−cₙ₋₁a_{n-1,01}] is an n×n diagonal matrix with unknown diagonal elements a_{0,00}−c₀a_{0,01}, and a_{n-1,00}−cₙ₋₁a_{n-1,01}.

On the other hand, for each ciphertext y=[y₀, . . . , y₂ₙ₋₁]εGF(q)²ⁿ⁻¹, let yP⁻¹=[z₀, z₁, . . . , z₂ₙ₋₁]. The codeword corresponding to the secret generator matrix SGₛ is [y′₀, y′₂, . . . , y′₂ₙ₋₂] where yP⁻¹ A⁻¹=[y′₀, . . . , y′₂ₙ₋₁]. By the fact that

$$[ {y}_{2 i}^{′} , {y}_{2 i + 1}^{′} ] = [ {z}_{2 i} , {z}_{2 i + 1} ] {A}_{i}^{- 1} = \frac{1}{\vert {A}_{i} \vert} [ {z}_{2 i} , {z}_{2 i + 1} ] [ \begin{matrix}{a}_{i , 11} & - {a}_{i , 01} \\ - {c}_{i} {a}_{i , 11} & {a}_{i , 00}\end{matrix} ] ,$$

one has

$${y}_{2 i}^{′} = \frac{{a}_{i , 11}}{\vert {A}_{i} \vert} ( {z}_{2 i} - {c}_{i} {z}_{2 i + 1} ) .$$

For each candidate permutation matrix P, one first chooses k independent messages χ₀, . . . , χₖ₋₁ and calculates the corresponding k independent ciphertexts y₀, . . . , yₖ₋₁. Using P and the above mentioned technique, one obtains a generator matrix

$${G}_{a} = {S}^{′} {G}_{s} diag [ \frac{{a}_{0 , 11}}{\vert {A}_{0} \vert} , … , \frac{{a}_{n - 1 , 11}}{\vert {A}_{n - 1} \vert} ] .$$

Thus in order to decode a ciphertext y, it is sufficient to decode the error correcting code given by the generator matrix Gₐ. This task becomes feasible for certain codes. For example, this task is equivalent to the problem of attacking a generalized Reed-Solomon code based McElience encryption scheme if Gₛ generates a generalized Reed-Solomon code.

In order for the attacks in the preceding paragraphs to work, the adversary needs to have the knowledge of the permutation matrix P. Since the number of candidate permutation matrices P is huge, this kind of attacks is still infeasible in practice.

Niederreiter's scheme and Sidelnikov-Shestakov's attack: Sidelnikov and Shestakov's cryptanalysis technique (1992) was used to analyze Niederreiter's scheme which is based on generalized Reed-Solomon codes. Let α=(α₀, . . . , αₙ₋₁) be n distinct elements of GF(q) and let υ=(υ₀, . . . , υₙ₋₁) be nonzero (not necessarily distinct) elements of GF(q). The generalized Reed-Solomon (GRS) code of dimension k, denoted by GRSₖ(α,υ), is defined by the following subspace.

GRSₖ(α,υ)={(υ₀ƒ(α₀), . . . ,υₙ₋₁ƒ(αₙ₋₁)):ƒ(χ)εGF(q)[χ]ₖ)}

where GF(q)[χ]ₖ is the set of polynomials in GF(q)[χ] of degree less than k. Alternatively, we can interpret GF(q)[χ]ₖ as a vector space of dimension k over GF(q). For each code word c=(υ₀ƒ(α₀), . . . , υₙ₋₁ƒ(αₙ₋₁)), ƒ(χ)=ƒ₀+ƒ₁χ+ . . . +ƒₖ₋₁χ^{k-1} is called the associate polynomial of the code word c that encodes the message (ƒ₀, . . . , ƒₖ₋₁). GRSₖ (α, υ) is an [n, k, d] MDS code where d=n−k+1.

Niederreiter's scheme (1986) replaces the binary Goppa codes in McEliece scheme using GRS codes as follows. For given security parameters n and k, one first chooses GRS code parameters α and υ. Let G be the k×n generator matrix for this GRS code. Choose a random k×k nonsingular matrix S over GF(q) and the public key is G′=SG and

$$t = ⌊ \frac{n - k}{2} ⌋ .$$

G″ linear code with the same rate and minimum distance as the code generated by G. The encryption and decryption process are the same as in the original McEliece scheme.

The best attack on Niederreiter scheme is presented by Sidelnikov and Shestakov (1992). In Sidelnikov-Shestakov attack, one recovers an equivalent private key (α, υ) from a public key G′ for the code GRSₖ (α, υ) as follows. For the given public key G′, one first computes the systematic form E(G′)=[II G″] (also called echelon form) using Gaussian elimination. An equation system is then constructed from E(G′) to recover a decryption key.

$$E ( {G}^{′} ) = ( \begin{matrix}1 & 0 & … & 0 & {b}_{0 , k} & … & {b}_{0 , n - 1} \\ 0 & 1 & … & 0 & {b}_{1 , k} & … & {b}_{1 , n - 1} \\ & & ⋱ & & ⋮ & & ⋮ \\ 0 & 0 & … & 1 & {b}_{k - 1 , k} & … & {b}_{k - 1 , n - 1}\end{matrix} ) \qquad ( 8 )$$

For the ith row bᵢ of E(G′), assume the associated polynomial is ƒ_{b}_{ᵢ}. Since the only non-zero elements are b_{i,i}, b_{i,k+1}, . . . , b_{i,n-1}, we have

$${v}_{0} {f}_{{b}_{i}} ( {α}_{0} ) = 0 \\ … \\ {v}_{i} {f}_{{b}_{i}} ( {α}_{i} ) = 1 \\ … \\ {v}_{n - 1} {f}_{{b}_{i}} ( {α}_{n - 1} ) = {b}_{i , n - 1} \qquad ( 9 )$$

Thus ƒ_{b}_{ᵢ} can be written as

$${f}_{{b}_{i}} = {c}_{{b}_{i}} \cdot {\prod }_{j = 1 , j \neq i}^{k} ( y - {α}_{j} ) \qquad ( 10 )$$

for some c_{b}_{ᵢ}0. By the fact that

GRSₖ(α,υ)=GRSₖ(aα+b,cυ) (11)

for all a, b, cεGF(q) with ab≠0, we may assume that α₀=0 and α₁=1. In the following, we try to recover α₂, . . . , αₙ₋₁. Using equation (10), one can divide the row entries in (8) by the corresponding nonzero entries in another row to get several equations. For example, if we divide entries in row i₀ by corresponding nonzero entries in row i₁, we get

$$\frac{{b}_{{i}_{0} , j}}{{b}_{{i}_{1} , j}} = \frac{{v}_{j} {f}_{{b}_{{i}_{0}}} ( {α}_{j} )}{{v}_{j} {f}_{{b}_{{i}_{1}}} ( {α}_{j} )} = \frac{{c}_{{b}_{{i}_{0}}} ( {α}_{j} - {α}_{{i}_{1}} )}{{c}_{{b}_{{i}_{1}}} ( {α}_{j} - {α}_{{i}_{0}} )} \qquad ( 12 )$$

for j=k, . . . , n−1. First, by taking i₀=0 and i₁=1, equation (12) could be used to recover αₖ, . . . , αₙ₋₁ by guessing the value of

$$\frac{{c}_{{b}_{0}}}{{c}_{{b}_{1}}}$$

which is possible when q is small. By letting i₀=0 and i₁=2, . . . , k−1 respectively, equation (12) could be used to recover αᵢ_{₁}. Sidelnikov and Shestakov (1992) also showed that the values of υ can then be recovered by solving some linear equation systems based on α₀, . . . , αₙ₋₁. Wieschebrink (2006) revised Niederreiter's scheme by inserting random column vectors into random positions of G before obtaining the public key G′. Couvreur et al (2013) showed that Wieschebrink's revised scheme is insecure under the product code attacks.

Berger and Loidreau (2005) recommend the use of sub codes of Niederreiter's scheme to avoid Sidelnikov and Shestakov's attack. Specifically, in Berger and Loidreau's scheme, one uses a random (k−l)×k matrix S′ of rank k−l instead of the k×k matrix S to compute the public key G′=S′G.

For smaller values of l, Wieschebrink (2010) shows that a private key (α, υ) for Berger and Loidreau scheme (2005) could be recovered using Sidelnikov-Shestakov algorithm. For larger values of l, Wieschebrink used product code to recover the secret values for Berger-Loidreau scheme. Let G′=SG be the (k−l)×n public generator matrix for Berger-Loidreau scheme, r₀, . . . , rₖ₋ₗ₋₁ be the rows of G′, and ƒ₀, . . . , ƒₖ₋ₗ₋₁ be the associated polynomials to those rows. For two row vector a, bεGF(q)ⁿ, the component wise product a*bεGF(q)n is defined as

a*b=(a₀b₀, . . . ,aₙ₋₁bₙ₋₁) (13)

By the definition in (13), it is straightforward to observe that

rᵢ*rⱼ=(υ₀²ƒᵢ(α₀)ƒⱼ(α₀), . . . ,υₙ₋₁²ƒᵢ(αₙ₋₁)ƒⱼ(αₙ₋₁)). (14)

For 2k−1≦n−2, if the code generated by rᵢ*rⱼ equals to GRS₂ₖ₋₁(α,υ′) for υ′=(υ₀², . . . , υₙ₋₁²) then the Sidelnikov-Shestakov algorithm could be used to recover the values α and υ. For 2k−1≦n−2, if the code generated by rᵢ*rⱼ does not equal to GRS₂ₖ₋₁(n,υ′), then the attack fails. Wieschebrink shows that the probability that the attack fails is very small. For the case of 2k−1>n−2, Wieschebrink applied Sidelnikov-Shestakov algorithm on the component wise product code of a shortened code of the original GRSₖ(α,υ).

The crucial step in Sidelnikov and Shestakov attack is to use the echelon form E(G)=[I|G′] of the public key to get minimum weight codewords that are co-related to each other supports. In the encryption scheme RLCE, each column of the public key G contains mixed randomness. Thus the echelon form E(G)=[I|G′] obtained from the public key G could not be used to build any useful equation system. In other words, it is expected that Sidelnikov and Shestakov attack does not work against the RLCE scheme.

Filtration attacks: Using distinguisher techniques, Couvreur et al. (2013) designed a filtration technique to attack GRS code based McEliece scheme. The filtration technique was further developed by Couvreur et al (2014) to attack wild Goppa code based McEliece scheme. In the following, we briefly review the filtration attack. For two codes C₁ and C₂ of length n, the star product code C₁*C₂ is the vector space spanned by a*b for all pairs (a, b)εC₁×C₂ where a*b is defined in (13). For C₁=C₂, C₁*C₁ is called the square code of C₁. It is showed in Couvreur et al (2014) that

$${dimC}_{1} {C}_{2} \leq \{ n , {dimC}_{1} {dimC}_{2} - ( \begin{matrix}dim ( {C}_{1} ⋂ {C}_{1} \\ 2\end{matrix} ) \} . \qquad ( 15 )$$

Furthermore, the equality in (15) is attained for most randomly selected codes C₁ and C₂ of a given length and dimension. Note that for C=C₁=C₂ and dim C=k, the equation (15) becomes

$${dimC}^{* 2} \leq min \{ n , ( \begin{matrix}k + 1 \\ 2\end{matrix} ) \} .$$

Couvreur et al (2014) showed that the square code of an alternant code of extension degree 2 may have an unusually low dimension when its dimension is larger than its designed rate. Specifically, this happens for wild Goppa codes over quadratic extensions. Using a shortening trick, Couvreur et al showed that the square of a shortened wild Goppa code of extension degree 2 is contained in an alternant code of non trivial dimension. Based on those observations, Couvreur et al designed the code filtration techniques. Specifically, create a family of nested codes defined for any a E {0, . . . , n−1} as follows.

C^{α}(0)⊃C^{α}(1)⊃. . . ⊃C^{α}(q+1) (16)

This family of nested codes is called a filtration. Roughly speaking, C^{α}(j) consists in the codewords of C which correspond to polynomials which have a zero of order j at position a. It is shown that the first two elements of this filtration are just punctured and shortened versions of C and the rest of them can be computed from C by computing star products and solving linear systems. Furthermore, the support values α₀, . . . , αₙ₋₁ for the Goppa code could be recovered by this nested family of codes efficiently. Thus the private keys for wild Goppa code based McEliece scheme could be recovered from the public keys.

The crucial part of the filtration techniques is the efficient algorithm to compute the nested family of codes in (16). For our RLCE scheme, the public generator matrix G′ contains random columns. Thus linear equations constructed in Couvreur et al (2014) could not be solved and the nested family (16) could not be computed correctly. Furthermore, the important characteristics for a code C to be vulnerable is that one can find a related code C₁ of dimension k such that the dimension of the square code of C₁ has dimension significantly less than min

$$\{ n , ( \begin{matrix}k + 1 \\ 2\end{matrix} ) \} .$$

To get experimental evidence that RLCE codes share similarity with random linear codes with respect to the above mentioned filtration attacks, we carried out several experiments using Shoup's NTL library. In the experiments, we used Reed-Solomon codes over GF(2¹⁰). The RLCE parameters are chosen as the 80-bit security parameter n=560, k=380, t=90, and r=1. For each given 380×560 generator matrix Gₛ of Reed-Solomon code, we selected another random 380×560 matrix CεGF(2¹⁰)^{380×560} and selected 2×2 matrices A₀, . . . , A₅₅₉. Each column cᵢ in C is inserted in Gₛ after the column gᵢ. The extended generator matrix is multiplied by A=diag[A₀, . . . , A₅₅₉] from the right hand side to obtain the public key matrix GεGF(2¹⁰)^{380×1120}. For each i=0, . . . , 1119, the matrix Gᵢ is used to compute the product code, where Gᵢ is obtained from G by deleting the ith column vector. In our experiments, all of these product codes have dimension 1119. We repeated the above experiments 100 times for 100 distinct Reed-Solomon generator matrices and the results remained the same. Since min

$$\{ 1119 , ( \begin{matrix}381 \\ 2\end{matrix} ) \} = 1119 ,$$

the experimental results meet our expectation that RLCE behaves like a random linear code. We did the same experiments for the dual code of the above code. That is, for a 180×560 generator matrix Gₛ of the dual code, the same procedure has been taken. In this time, after deleting one column from the resulting public key matrix, the product code always had dimension 1119 which is the expected dimension for a random linear code.

Algebraic attacks: Faugere, Otmani, Perret, and Tillich (2010) developed an algebraic attack against quasi-cyclic and dyadic structure based compact variants of McEliece encryption scheme. In a high level, the algebraic attack tries to find χ*, y*εGF(q)ⁿ such that Vₜ (χ*,y*) is the parity check matrix for the underlying alternant codes of the compact variants of McEliece encryption scheme. Vₜ (χ*,y*) can then be used to break the McEliece scheme. Note that this Vₜ(χ*, y*) is generally different from the original parity check matrix Vₜ(χ, y) in (1). The parity check matrix Vₜ(χ*, y*) was obtained by solving an equation system constructed from

Vₜ(χ*,y*)G^{T}=0, (17)

where G′ is the public key. Faugere, Otmani, Perret, and Tillich (2010) employed the special properties of quasi-cyclic and dyadic structures (which provide additional linear equations) to rewrite the equation system obtained from (17) and then calculate Vₜ(χ*, y*) efficiently.

Faugere, Gauthier-Umana, Otmani, Perret, and Tillich (2011) used the algebraic attack to design an efficient Goppa code distinguisher to distinguish a random matrix from the matrix of a Goppa code whose rate is close to 1. For instance, it was showed that the binary Goppa code obtained with m=13 and r=19 corresponding to a 90-bit security key is distinguishable.

It is challenging to mount the above mentioned algebraic attacks on the RLCE encryption scheme. Assume that the RLCE scheme is based on a Reed-Solomon code. Let G be the public key and (S, Gₛ, A, P) be the private key. The parity check matrix for a Reed-Solomon code is in the format of

$${V}_{t} ( α ) = [ \begin{matrix}1 & α & {α}^{2} & … & {α}^{n - 1} \\ 1 & {α}^{2} & {α}^{4} & … & {α}^{2 ( n - 1 )} \\ ⋮ & ⋮ & ⋮ & ⋱ & ⋮ \\ 1 & {α}^{t + 1} & {α}^{2 ( t + 1 )} & … & {α}^{( t + 1 ) ( n - 1 )}\end{matrix} ] . \qquad ( 18 )$$

The algebraic attack requires one to obtain a parity check matrix Vₜ(α*) for the underlying Reed-Solomon code from the public key G, where α* may be different from α. Assume that Vₜ(α*)=[υ₀, . . . , υₙ₋₁]εGF(q)^{(t+1)×n} is a parity check matrix for the underlying Reed-Solomon code. Let V′ₜ(α*)εGF(q)^{(t+1)×n(r+1)} be a (t+1)×n(r+1) matrix obtained from Vₜ(α*) by inserting r column vectors 0 after each column of Vₜ(α*). That is,

V′ₜ(α*)=[υ₀,0,υ₁,0, . . . ,υₙ₋₁,0]. (19)

Then we have

$$\begin{matrix}{V}_{t}^{′} ( {α}^{*} ) {G}_{1}^{T} = {{V}_{t}^{′} ( {α}^{*} ) [ {g}_{0} , {C}_{0} , … , {g}_{n - 1} , {C}_{n - 1} ]}^{T} \\ = {{V}_{t} ( {α}^{*} ) [ {g}_{0} , … , {g}_{n - 1} ]}^{T} \\ = {V}_{t} ( {α}^{*} ) {G}_{s}^{T} \\ = 0.\end{matrix} \qquad ( 20 )$$

We cannot build an equation system for the unknown V′ₜ(α*) from the public key G=SG₁AP directly since the identity (20) only shows the relationship between V′ₜ(α*) and G₁. In other words, in order to build an equation system for V′ₜ(α*), one also needs to use unknown variables for the non-singular matrix A and the permutation matrix P. That is, we have

V′ₜ(α*)(A⁻¹)^{T}(P⁻¹)^{T}G^{T}=V′ₜ(α*)(GP⁻¹A⁻¹)^{T}=V′ₜ(α*)G₁^{T}S^{T}=0. (21)

with an unknown α*, an unknown permutation matrix P, and an unknown matrix A=diag[A₀, . . . , Aₙ₋₁] which consists of n dense nonsingular (r+1)×(r+1) matrices AᵢεGF(q)^{(r+1)×(r+1)} as defined in (3). In order to find a solution α*, one first needs to take a potential permutation matrix P⁻¹ to reorganize columns of the public key G. Then, using the identity V′ₜ(α*)(A⁻¹)^{T}(P⁻¹)^{T}G^{T}=0, one can build a degree (t+1)(n−1)+1 equation system of k(t+1) equations in n(r+1)²+1 unknowns. In case that k(t+1)≧n(r+1)²+1, one may use Buchberger's Gröbner basis algorithms to find a solution α*. However, this kind of algebraic attacks are infeasible due to the following two challenges. First the number of permutation matrices P is too large to be handled practically. Secondly, even if one can manage to handle the large number of permutation matrices P, the Gröbner basis (or the improved variants such as F₄ or F₅) are impractical for such kind of equation systems.

The Gröbner basis algorithm eliminates top order monomial (in a given order such as lexicographic order) by combining two equations with appropriate coefficients. This process continues until one obtains a univariate polynomial equation. The resulting univariate polynomial equation normally has a very high degree and Buchberger's algorithm runs in exponential time on average (the worst case complexity is double exponential time). Thus Buchberger's algorithm cannot solve nonlinear multivariate equation systems with more than 20 variables in practice. But it should also be noted that though the worst-case Gröbner basis algorithm is double exponential, the generic behavior is generally much better. In particular, if the algebraic system has only a finite number of common zeros at infinity, then Grobner basis algorithm for any ordering stops in a polynomial time in dⁿ where d=max{dᵢ: dᵢ is the total degree of ƒᵢ} and n is the number of variables.

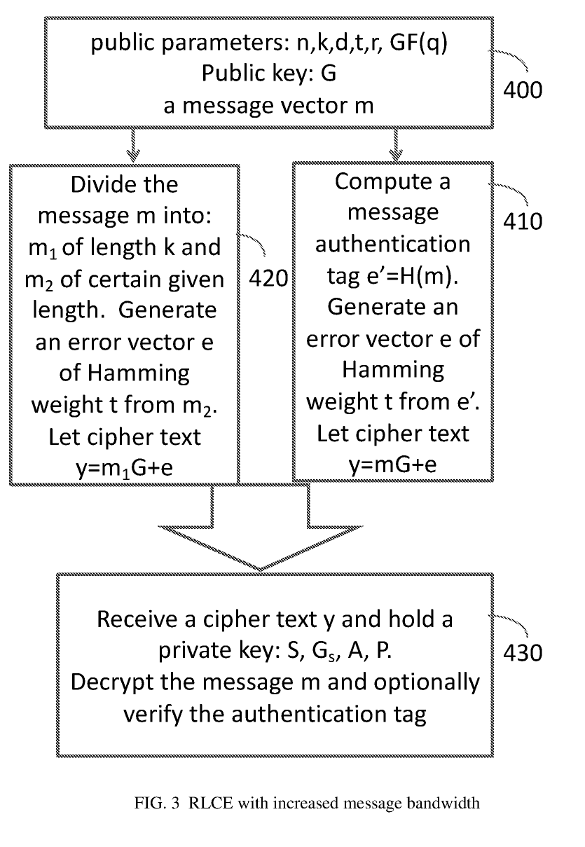

Encoding messages within the error vector: In order to increase the RLCE encryption scheme bandwith, one may use the process in FIG. 3 to include a partial message or an authentication tag within the error vector. Referring therefore to FIG. 3, for given public parameters n,k,d,t,r,GF(q), a public key G, and a row message vector m in the box 400, let H be a message authentication code algorithm. The message encryption engine 410 computes e′=H(m) as the message authentication tag and generates the error vector e using the authentication tag e′. Finally, the message encryption engine 410 encrypts the message m using the error vector e. At the receiving side 430, the receiver decrypts the message m from the ciphertext and recovers the message authentication tag e′ from the error vector e. The receiver accepts the decrypted message m only if e′=H(m). Alternatively, the message encryption engine 420 divides the message m into two parts m₁εGF(q)^{k} and m₂ (of certain given length). The message encryption engine 420 generates the error vector e using the message m₂. Finally, the message encryption engine 420 encrypts the message m₁ using the error vector e. At the receiving side 430, the receiver decrypts the message m₁ from the ciphertext and recovers the message m₂ from the error vector e.

Practical Considerations: In order to reduce the message expansion ratio which is defined as the rate of ciphertext size and corresponding plaintext size, it is preferred to use a smaller r for the RLCE encryption scheme. Indeed, the experimental results show that r=1 is sufficient for RLCE to behave like a random linear code. As mentioned in the introduction section, the most powerful message recovery attack (not private key recovery attack) on McEliece encryption schemes is the information-set decoding attack. For the RLCE encryption scheme, the information-set decoding attack is based on the number of columns in the public key G instead of the number of columns in the private key Gₛ. For the same error weight t, the probability to find error-free coordinates in (r+1)n coordinates is different from the probability to find error-free coordinates in n coordinates. Specifically, the cost of information-set decoding attacks on an [n,k,t;r]-RLCE scheme is equivalent to the cost of information-set decoding attacks on a standard [(r+1)n,k;t]-McEliece scheme.

Taking into account of the cost of recovering McEliece encryption scheme secret keys from the public keys and the cost of recovering McEliece encryption scheme plaintext messages from ciphertexts using the information-set decoding methods, we generated a recommended list of parameters for RLCE scheme in Table 1. For the recommended parameters, the default underlying linear code is taken as the Reed-Solomon code over GF(q) and the value of r is taken as 1. For the purpose of comparison, we also list the recommended parameters for the binary Goppa code based McEliece encryption scheme. It is recommended to use semantic secure message coding approach so that one can store the public key as a systematic generator matrix. For the binary Goppa code based McEliece encryption scheme, the systematic generator matrix public key is k(n−k) bits. For RLCE encryption scheme over GF(q), the systematic generator matrix public key is k(n(r+1)−k) log q bits. It is observed that RLCE scheme generally has larger but acceptable public key size. Specifically, for the same security level, the public key size for the RLCE scheme is approximately four to five times larger than the public key size for binary Goppa code based McEliece encryption scheme. For example, for the security level of 80 bits, the binary Goppa code based McEliece encryption scheme has a public key of size 56.2 KB, and the RLCE-MDS scheme has a public key of size 267≈5×56.2 KB.

TABLE 1
Parameters for RLCE: n, k, t, q, key size (r = 1 for all parameters), where
“360, 200, 80, 101 KB” under column “RLCE-MDS code”
represents n = 360, k = 200, t = 80.

| Security | RLCE-MDS code | binary Goppa code |
|---|---|---|
| 60 | 360, 200, 80, 101 KB | 1024, 524, 50, 19.8 KB |
| 80 | 560, 380, 90, 267 KB | 1632, 1269, 34, 56.2 KB |
| 128 | 1020, 660, 180, 0.98 MB | 2960, 2288, 57, 187.7 KB |
| 192 | 1560, 954, 203, 2.46 MB | 4624, 3468, 97, 489.4 KB |
| 256 | 2184, 1260, 412, 4.88 MB | 6624, 5129, 117, 0.9 MB |

### REFERENCE CITED

Marco Baldi, Marco Bianchi, Franco Chiaraluce, Joachim Jakob Rosenthal, and Davide Mose' Schipani. Method and apparatus for public-key cryptography based on error correcting codes. U.S. Pat. No. 9,191,199 B2 (2015)
Martin Tomlinson, Cen Jung Tjhai. Public key cryptosystem based on goppa codes and puf based random generation. U.S. Pat. No. 8,958,553 B2 (2015)
Martin Tomlinson and Cen Jung Tjhai. Public key encryption using error correcting codes. WO2012066328 A1 (2012)
Eran Kanter, Ido Kanter. A secure and linear public-key cryptosystem based on parity-check error-correcting code. WO2001050675 A2 (2001).
Yongge Wang. Method and Apparatus for Random Linear Code Based Public Key Encryption Schemes. US Patent application U.S. 62/240,182, filed on Oct. 12, 2015.
Yongge Wang. Quantum Resistant Random Linear Code Based Public Key Encryption Scheme RLCE. Proc. ISIT 2016. IEEE Press, 2016.

What is claimed is:

1. A method for generating a public key G and for generating a private key K from an error correcting code generator matrix Gₛ, the method comprising:
a) obtaining said k×n generator matrix Gₛ for an [n, k, d] linear code over a finite field GF(q), wherein n, k, d, q are positive integers;
b) obtaining a k×n(r+1) matrix G₁ by inserting rn random columns into said matrix Gₛ, wherein r is a positive integer;
c) selecting a random k×k non-singular matrix S;
d) selecting a random n(r+1)×n(r+1) non-singular matrix A;
e) selecting a random n(r+1)×n(r+1) permutation matrix P;
f) computing said public key G=SG₁AP; and
g) obtaining said private key K=(S, Gₛ, A, P).

2. The method of claim 1 wherein computing said k×n(r+1) matrix G₁ comprises:
a) obtaining matrix columns g₀, . . . , gₙ₋₁ from said generator matrix Gₛ;
b) selecting random k×r matrices C₀, C₁, . . . , Cₙ₋₁ where C₀, C₁, . . . , Cₙ₋₁ have elements in GF(q); and
c) obtaining said k×n(r+1) matrix G₁=[g₀, C₀, g₁, C₁, . . . , gₙ₋₁, Cₙ₋₁].

3. The method of claim 1 wherein selecting said non-singular matrix A comprises:
a) selecting random (r+1)×(r+1) matrices A₀, A₁, . . . , Aₙ₋₁ where A₀, A₁, . . . , Aₙ₋₁ have elements in GF(q); and
b) obtaining said n(r+1)×n(r+1) matrix
$$A = [ \begin{matrix}{A}_{0} & & & \\ & {A}_{1} & & \\ & & ⋱ & \\ & & & {A}_{n - 1}\end{matrix} ] .$$

4. The method of claim 3 wherein said k×n(r+1) matrix G₁ is computed according to the method of claim 2.

5. A method for transmitting a message vector m between a sender and a receiver securely, the method comprising:
a) at the receiver: obtaining a k×n generator matrix Gₛ for an [n, k, d] linear code over a finite field GF(q), wherein n, k, d, q, t are positive integers, and wherein a linear code generated by said generator matrix Gₛ corrects at least t errors; calculating a k×n(r+1) public key matrix G using said Gₛ; sending said public key matrix G to said sender; and obtaining a private key K from said Gₛ;
b) at the sender: obtaining said integer n; obtaining said integer k, obtaining said integer d; obtaining said finite field GF(q); obtaining said message encryption public key G from said receiver; obtaining said message vector m having elements in GF(q); generating an error vector e where e has elements in GF(q), and where e has a predetermined weight t; computing a ciphertext vector y=mG+e; and sending said ciphertext vector y to the receiver;
c) at the receiver: obtaining said ciphertext vector y from the sender; computing an inverse P⁻¹ of said permutation matrix P; computing an inverse A⁻¹ of said non-singular matrix A; computing an inverse S⁻¹ of said non-singular matrix S; computing a vector yP⁻¹ A⁻¹ having a length n(r+1); selecting a sub-vector y′ of said vector yP⁻¹ A⁻¹, where y′ has a length n; using said private generator matrix Gₛ to decode said sub-vector y′ into a vector m′, where m′ has a length k; computing said plaintext message m=m'S⁻¹; and checking a validity of said message m.

6. The method of claim 5 wherein said public key G and wherein said private key K are generated according to the method of claim 4.

7. The method of claim 6 wherein selecting said sub-vector y′ comprises:
a) obtaining elements y′₀, . . . , y′ₙ₍ᵣ₊₁₎₋₁ of said vector yP⁻¹ A⁻¹; and
b) setting said sub-vector y′=[y₀, y′ᵣ₊₁, . . . , y′₍ₙ₋₁₎₍ᵣ₊₁₎].

8. The method of claim 7 wherein checking said validity of said message m comprises:
a) computing a Hamming weight w=weight(y−mG); and
b) accepting said message m if w≦t.

9. The method of claim 8 wherein generating said error vector e comprises:
a) computing a message authentication tag e′=H(m) wherein H is a message authentication code algorithm; and
b) computing said error vector e from said message authentication tag e′.

10. The method of claim 8 wherein generating said error vector e comprises:
a) selecting a second private message m′; and
b) computing said error vector e from said second message m′.

11. The method of claim 10 wherein recovering said second message m′ from said ciphertext y comprises:
a) computing said first message m using the method of claim 5;
b) computing said error vector e=y−mG; and
c) computing said second message m′ from said error vector e.
